(19) United States
(12) Patent Application Publication
(10) Pub. No.: US 2002/0050662 A1
(43) Pub. Date: May 2, 2002

(54) Extrusion coating method

(76) Inventor: Shigetoshi Kawabe, Tokyo (JP)

Correspondence Address: BIERMAN MUSERLIAN AND LUCAS, 600 THIRD AVENUE, NEW YORK, NY, 10016

(21) Appl. No.: 09/933,250

(22) Filed: Aug. 20, 2001

(30) Foreign Application Priority Data
Aug. 24, 2000 (JP) 253589/2000

(51) Int. Cl. B29C 47/06; B05D 3/12; B05D 1/30

(52) U.S. Cl. 264/172.19; 264/173.11; 427/420; 427/356

(57) ABSTRACT

An extrusion coating method of extruding a coating solution from a coater onto a web-shaped substrate, comprising steps of: conveying the substrate in a conveying direction; supporting by coming in contact with a first side surface of the substrate by a back-roll; and extruding simultaneously at least a lowermost layer solution and an adjacent layer solution onto a second side surface of the supported substrate in such a way that the lower most layer solution is coated on the second surface and the adjacent layer is superimposed on the lowermost layer solution, wherein a viscosity Va (Pa·s) of the lowermost layer solution and a viscosity Vb (Pa·s) of the adjacent layer solution satisfy the following formula:

Vb/Va≦2.5.

### FIELD OF THE INVENTION

The present invention relates to an extrusion coating method of extruding a coating solution from coater onto a web-shaped substrate of which surface opposite to a coating surface is supported by a back roll, and more specifically to an extrusion coating method which make it possible to coat high viscosity coating compositions at low thickness and high speed.

### BACKGROUND OF THE INVENTION

Conventionally known as methods for applying coating compositions onto a continuously moving web-shaped substrate (hereinafter referred occasionally to as the web) have been a dip coating method, a blade coating method, an air knife coating method, a wire bar coating method, a gravure coating method, a reverse coating method, a reverse roll coating method, an extrusion coating method, a slide coating method, a curtain coating method, and the like. In these methods, in order to obtain an uniform dried layer thickness in the width direction of the web, special attention has been paid to the dimensional accuracy of the coating apparatus, and coating has been carefully carried out. Of these coating methods, the extrusion coating method of the present invention will now be briefly described with reference to the drawings.

FIG. 1 is a schematic view showing coating, in which an extrusion coating system is applied, onto the supported section of a web of which the surface opposite to the coating surface (hereinafter referred simply to as the opposite surface) is supported by a back roll. In FIG. 1, numeral 1 shows a web, which is continuously conveyed from up-stream to down-stream in the direction shown by the arrow (in FIG. 1, from the bottom to the top). Numeral 2 shows a back roll, and 3 shows a simultaneous multilayer extrusion coater (hereinafter referred simply to as the coater) . The coater, as described herein, refers to one which uniformly supplies coating compositions in the coating width direction and applies the resulting coating compositions onto a web. Constitution will be described with reference to the schematic view of coater 3, shown in FIG. 2. The up-stream side, as described in the present invention, refers to the side of web 1 onto which the composition being fed, while the down-stream side, as described herein, refers to the opposite side. The coating compositions are extruded from coater 3 and applied onto the supported section of said web which is conveyed while the opposite surface is supported by back roll 2, whereby coating is carried out. This system has been known as a coating system in which uniform coating thickness is readily obtained due to the fact that the flatness of said support is maintained employing said back roll 2 disposed on the opposite surface of web 1.

FIG. 2 is a schematic view showing the cross-section of a three-layer coating coater. In FIG. 2, 301a, 301b, 301c, and 301d each show a bar constituting coater 3, and fixed employing a bolt. 302a, 302b, 302c, and 302d each show a lip at the end of each bar, and 303a, 303b, 303c, and 303d each show a slit formed between each of the bars. 304a, 304b, and 304c each show a chamber disposed in the width direction of coater 3. Each coating composition is supplied at the center in the width direction of each chamber or an optional position, spread in the coating width direction, and extruded onto said web from said each lip via each said slit, whereby coating is carried out. In said simultaneous multilayer extrusion coater, it is possible to constitute chambers as well as slits while matching the number of desired coating layers. The edges of the coating width of said coater are sealed so as to obtain the desired coating width utilizing various width adjusting means, side plates, and the like.

Regarding the coating system shown in FIG. 1, many patents have been applied for which relate to coating systems, coating apparatus, and the like, such as coating methods employing a single layer disclosed in Japanese Patent Publication Open to Public Inspection Nos. 56-95363 and 50-142643, multilayer coating systems disclosed in Japanese Patent Publication Open to Public Inspection Nos. 45-12390 and 46-236, and others. In these coating methods, coating is carried out in which the distance between the coater and the support supported by the back roll is kept at 1 mm or less.

Further, in an extrusion coating methods in which coating is carried out onto a web the opposite surface of which is supported by a back roll, it is frequently impossible to carry out coating when the distance between the web and the lip from which the coating composition flows out section at the edge of the coater is more than two times the coating thickness. Accordingly, in order to achieve thin layer coating, it is required to make said distance much shorter. Thus, problems occur occasionally in which the thickness of coating layer is not uniform due to effects of the orthogonality of the lip at the edge of the coater in the coating width direction, the cylindricality of the back roll, fluctuations in rotation of the back roll, dirt and foreign substances on the roll surface, and the like, whereby it is impossible to carry out desired coating thickness.

As thin layer coating methods which are applied to the web the opposite surface of which is supported by a back roll, U.S. Pat. No. 2,681,294 discloses that coating is carried out while reducing pressure on the up-stream side of a coater. However, it is found that the method disclosed in said U.S. Pat. No. 2,681,294 is only effective for cases of low viscosity coating compositions, because when the rate of coating is increased, non-coated spots tend to form due to effects of air accompanied with the web surface. However, when the viscosity of coating compositions is low, it is difficult to achieve a high speed coating. In recent years, in the case of coating of high viscosity coating compositions and of high viscosity coating compositions at high speed, an extrusion coating system has been employed in which coating is carried out in such a manner that a support, of which opposite surface is not supported by a back roll, is brought into pressure contact with a coater.

FIG. 3 is a schematic view showing coating employing an extrusion coating system in which a web is not supported by a back roll. In FIG. 3, numeral 4 shows a support roll and other symbols are the same as for FIG. 1.

The support roll, as described herein, refers to two conveying rolls disposed on the opposite surface of a web before and after the coater in order to maintain the desired flatness of said web when coating is carried out onto said web the opposite surface of which is not supported by a back roll, employing the extrusion coating system. Incidentally, the roll on the up-stream side from the coater in the conveying direction may be positioned on the coating surface side.

Regarding the coating system shown in FIG. 3, many patents have been applied for which relate to coating systems, coating apparatus, such as coating methods employing a single layer disclosed in Japanese Patent Publication Open to Public Inspection Nos. 50-138036, 55-165172, and 1-288364; multilayer coating systems disclosed in Japanese Patent Publication Open to Public Inspection Nos. 2-251265, 2-258862, and 5-19262; and others.

These extrusion coating methods in which coating is carried out onto a web, the opposite surface of which is not supported by a back roll, are markedly suitable for high speed coating at high viscosity. However, since the opposite surface of said web is not held, the flatness of said web markedly affects the uniformity of the coating thickness. Specifically, in the case of thick webs, it is difficult to maintain flatness. Thus problems occur in which it is impossible to carry out desired coating due to the non-uniformity of the coated layer.

### SUMMARY OF THE INVENTION

An object of the present invention is to provide a coating method capable of carrying out uniform coating which is not affected by the flatness of the web, employing an extrusion coating method in which the opposite surface of said web is not supported by a back roll, and further to provide an extrusion coating method capable of decreasing the thickness of a coating composition at high viscosity (for example, not less than 0.01 Pa·s) and of achieving high speed coating.

The present inventor has discovered that the above objects can be accomplished by employing the embodiments described below.

1) An extrusion coating method of extruding a coating solution from a coater onto a web-shaped substrate, comprising steps of:

conveying the substrate in a conveying direction;

supporting by coming in contact with a first side surface of the substrate by a back-roll; and

extruding simultaneously at least a lowermost layer solution and an adjacent layer solution onto a second side surface of the supported substrate in such a way that the lower most layer solution is coated on the second surface and the adjacent layer is superimposed on the lowermost layer solution,

wherein a viscosity Va (Pa·s) of the lowermost layer solution and a viscosity Vb (Pa·s) of the adjacent layer solution satisfy the following formula.

Vb/Va≦2.5

2) The extrusion coating method described in Item.1), wherein the viscosity Va, the viscosity Vb, a thickness Ta (μm) of the lowermost layer solution and a thickness Tb of the adjacent layer solution satisfy the following formula.

(Vb/Va)/(Tb/Ta)<7.5

3) The extrusion coating method described in Item.1), wherein the viscosity Va and the viscosity Vb satisfy the following formula.

2.5≦(Vb/Va)≦30

4) The extrusion coating method described in Item.2), wherein the viscosity Va, the viscosity Vb, the thickness Ta and the thickness Tb satisfy the following formula.

0.8≦(Vb/Va)/(Tb/Ta)<7.5

5) The extrusion coating method described in Item.1), wherein the adjacent layer solution is a solution diluting the lowermost layer solution.

6) The extrusion coating method described in Item.1), wherein the viscosity Vb is not less than 0.01 Pa·s.

7) The extrusion coating method of described in Item.6), wherein the viscosity Vb is not more than 3.0 Pa·s.

8) An extrusion coating method described in item 1), wherein in said extrusion coating method, coating is carried out in such a manner that by employing a simultaneous multilayer extrusion coater comprised of at least two slit which individually extrude a coating solution and at least three bars constituting said slits, two or more solutions are applied onto said web-shaped substrate, and the following formula is satisfied:

W≦hn≦3×W

wherein hn is the gap between said web-shaped substrate and the nth lip from the upper stream in the conveying direction, and W is the total coating thickness, immediately after coating, which is formed by applying coating composition(s) which have been applied onto said web-shaped substrate at the further upper stream of said lip.

By employing these methods, it is possible to carry out high speed and thin layer extrusion coating onto a web held by a back roll, employing a highly viscous coating solution. The present invention will now be detailed with reference to the drawings.

### BRIEF DESCRIPTION OF THE DRAWINGS

FIG. 1 is a schematic view showing coating onto a held section of a support of which surface opposite the coating surface is held by a back roll, employing an extrusion coting system.

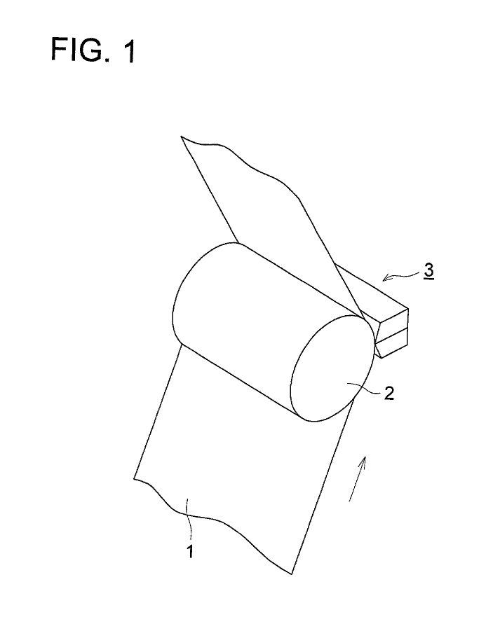

FIG. 2 is a schematic cross-sectional view of an extrusion coater for three-layer simultaneous multilayer coating.

FIG. 3 is a schematic view showing coating onto a web of which opposite surface is not held by a back roll, employing an extrusion coating system.

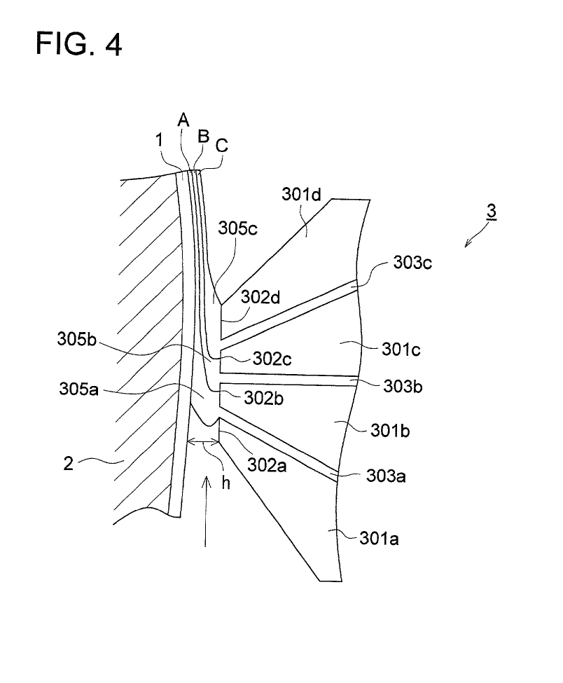

FIG. 4 is a schematic view showing a coating state at the end of a simultaneous multilayer extrusion coater during simultaneous multilayer coating.

FIG. 5 is a schematic view showing a coating state at the end of a simultaneous multilayer extrusion coater during simultaneous multilayer coating.

Each of FIG. 6(a) and FIG. 6(b) is a schematic view showing a coating state employing a three-layer coating simultaneous multilayer extrusion coater in which the distance between each lip and the web is varied.

FIG. 7 is a schematic view showing a coating state of the end of a simultaneous multilayer extrusion coater during simultaneous multilayer coating, employing a simultaneous multilayer extrusion coater in which the distance between each lip and the web is the same.

### DETAILED DESCRIPTION OF THE INVENTION

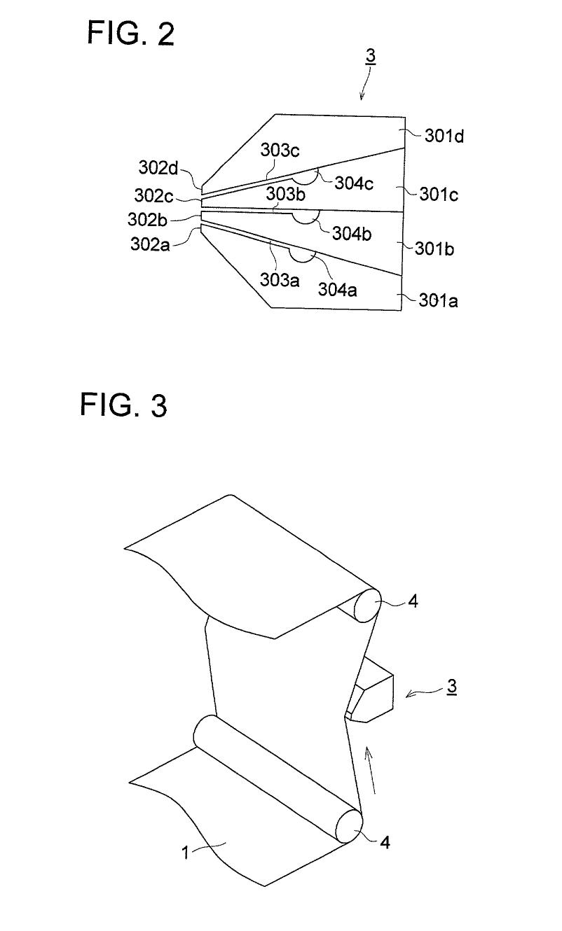

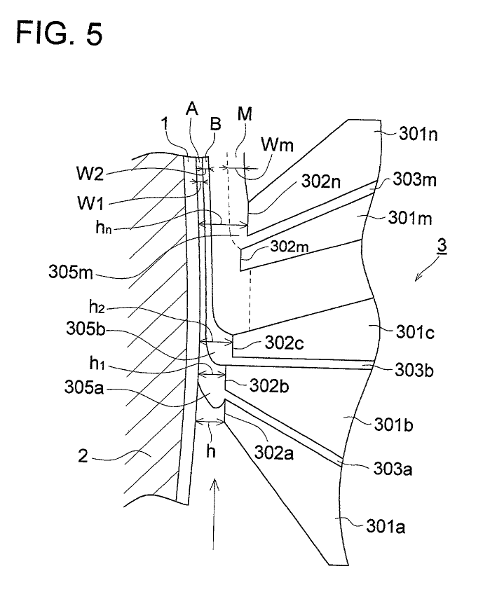

FIG. 4 is a schematic view showing the coating state at the coater end during simultaneous multilayer coating. Though not shown in FIG. 4, said coater is fixed and back roll 2 rotates in the same direction while matching the conveying speed. In FIG. 4, a coater for simultaneously coating three layers is shown, and of course, said coater is not limited to the one shown in FIG. 4. In FIG. 4, 305a shows a coating solution extruded from slit 303a, 305b shows a coating solution extruded from slit 303b, and 305c shows a coating solution extruded from slit 303c. Each of A, B, and C shows a layer formed by applying each extruded coating solution onto web 1. In the present invention, A is designated as the lowermost layer, B is designated as a layer adjacent to said lowermost layer A (hereinafter referred occasionally to as an adjacent layer), and C is designated as the uppermost layer. Numeral 1 shows a web continuously conveyed from up-stream to the down-stream in the direction (in FIG. 4, from the bottom to the top) shown by the arrow in FIG. 4. h shows the distance between web 1 and the lip. Other symbols are the same as those in FIG. 2.

Incidentally, the up-stream side, as described in the present invention, refers to the side from which web 1 is conveyed while assuming coater 3 as the basis. Namely, in FIG. 4, the uppermost stream side lip of coater 3, as described herein, refers to 302a, while the lowermost side lip refers to 302d. FIG. 4 shows the case in which the distance between each of lips 302a, 302b, 302c, and 302d and web is the same.

With reference to FIG. 4, the movement of each of said coating compositions, which constitutes each layer, will now be described. Each of coating compositions 305a, 305b, and 305c, which has been extruded from each of slits 303a, 303b, and 303c of coater 3 and has been placed between each of lip 302b, 302c, and 303d and web 1 moving at a certain conveying speed is subjected to application of sheer stress. As a result, each coating solution is rapidly accelerated to the conveying speed (being the coating speed) of web 1 from the still state, and is subjected to an elongated state. During this, when the viscosity of said coating solution is high with respect to said coating speed, said coating solution hardly corresponds to elongation. As a result, a state occurs in which said coating composition is torn off, and it is impossible to carry out coating due to formation of non-coated spots. In order to overcome said drawback, it is necessary to carry out coating by decreasing the coating speed or to increase the supply rate of said coating solution as well as to increase distance h between web 1 and said lip so as to correspond to the increase in the supply rate. However, if the coated layer thickness increases, it is impossible to carry out high-speed thin layer coating. Further, when the viscosity of said coating solution is low with respect to the coating speed, it becomes possible to elongate said coating composition. Accordingly it is possible to carry out high-speed coating. As a result, coating solutions in the limited range are only applicable for coating.

However, when the viscosity of coating solution 305a, constituting lowermost layer A is adjusted to be lower than that of coating solution 305b, constituting adjacent layer B, said coating solution 305a extruded from slit 303s is quickly elongated between lip 302b and web 1 to form a thin layer. On the other hand, coating composition 305b extruded from slit 303b, which constitutes the adjacent layer works as if it is a slip layer, and the elongation rate of coating solution 305b between lip 302c and said coating solution 305a markedly becomes smaller. As a result, the coating solution is not torn off, and it is possible to carry out desired coating. Further, due to the marked decrease in the elongation rate of said coating solution 305b, the coating solution is not torn off. Thus it is possible to carry out thin layer coating by decreasing the supply amount of said coating solution.

Since a high viscosity layer is not subjected to quick elongation, the average speed of an individual high viscosity layer decreases. If the supply amount of a high viscosity layer coating solution is kept constant, the thickness of said high viscosity layer increases instead of the decrease in the average speed. When the thickness increases, it is possible to increase the distance between the lip and the web. As a result, the supply amount of said high viscosity layer coating solution increases. Namely, without an increase in the thickness of a finished layer after coating, it is possible to increase the distance between the lip and the web. On the other hand, when said distance is not increased, it is possible to decrease the supply amount matching the increase in thickness of said high viscosity layer. Thus, it becomes possible to decrease the finished thickness of said high viscosity layer, namely it is possible to carry out thin layer coating.

The greater difference between the viscosity of low viscosity coating solution 305a constituting lowermost layer A and the viscosity of high viscosity coating solution 305b constituting adjacent layer B, the more said low viscosity coating solution 305a constituting lowermost layer A is subjected to elongation and the less said high viscosity coating solution 305b constituting adjacent layer B is subjected to elongation. As a result, said effects are markedly exhibited. It is preferable that coating is carried out to satisfy the following relationship:

2.5≦(viscosity Vb of adjacent layer solution)/(viscosity Va of lowermost layer solution). Said relationship is more preferably 2.5≦(viscosity Vb of adjacent layer solution)/(viscosity Va of lowermost layer solution)≦30

Further, when each coating thickness of adjacent layer B and lowermost layer A is taken into account, it is preferable that coating is carried out adjusting the viscosity Va of lowermost layer solution 305a and the thickness Ta of the lowermost layer A, the viscosity Vb of adjacent layer solutions 305b and the thickness Tb of the adjacent layer so that the following relationship is satisfied:

(viscosity Vb of adjacent layer solution/viscosity Va of lowermost layer solution)/(thickness Tb of adjacent layer B/thickness Ta of lowermost layer A)<7.5.

It is more preferable that coating is carried out adjusting the same so that the following relationship is satisfied: 0.8≦(viscosity Vb of the adjacent layer solution/viscosity Va of the undermost layer solution)/(viscosity of the lowermost layer coating composition/(thickness Tb of the adjacent layer/thickness Ta of the lowermost layer)<7.5. As the layer thickness ratio increases, it is possible to increase the viscosity ratio. Namely, as the thickness Ta of lowermost layer A decreases, it is possible to lower the viscosity Va of coating solution, constituting lowermost layer A. When the thickness Va of lowermost layer A is large, an excessive decrease in viscosity Va of coating solution 305a results in instability of the coating thickness and it becomes impossible to carry out desired coating due to problems in which the entire coating layer results in fluctuations due to non-uniform layer thickness of lowermost layer A. Namely, in addition to an increase in difference between the viscosity of adjacent layer B-constituting coating composition 305b and the lowermost layer A-constituting coating composition 305a, it is preferable to adjust the viscosity ratio corresponding to these layer thickness ratios.

In order to minimize the roughness of a coating layer surface due to separation and coagulation of lowermost layer A coating solution 305a, it is preferable that employed as said lowermost layer A coating solution 305a, is diluted adjacent layer B coating solution, or a liquid, which is compatible with solvents employed in adjacent layer B coating solution 305B, be employed.

Specifically, when coating solution solvents, which are employed in the adjacent layer, are individually employed in the lowermost layer solution, after drying, the lowermost layer disappears due to evaporation. Therefore, without any consideration of compositions of the lowermost layer and the adjacent layer, it is possible to carry out high speed coating and thin layer coating which is not capable of being carried out employing only a high viscosity adjacent layer.

When the viscosity of adjacent layer B solution 305b approaches that of lowermost layer A solution 305a, effects of a decrease in viscosity of said lowermost layer A solution 305a are not obtained. When the viscosity of said adjacent layer coating composition is at least 0.01 Pa·s, effects of the present invention are markedly exhibited. It is more preferable that the viscosity of said adjacent layer B solution of the present invention is from 0.01 to 3.0 Pa·s.

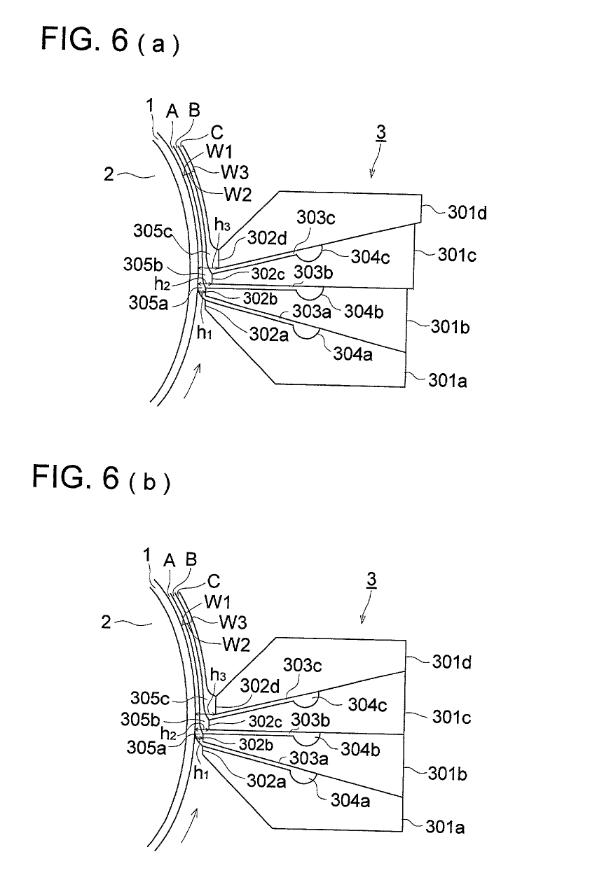

FIG. 5 is a schematic view showing a coating state of a coater end during simultaneous multilayer coating, employing a coater in which the distance between each lip and web 1 is varied. In FIG. 5, 301m shows a mth bar constituting said coater, 302m shows a lip at the edge of bar 301m, 301n shows a nth bar constituting a die coater, 302n show a lip at the edge of bar 301n, and 303m shows a slit between bar 301m and 301n. 305m shows a coating solution extruded from slit 303m.

M shows an uppermost layer which is formed by applying coating solution 305m extruded from slit 303m onto web 1. h shows the gap between each lip and web 1, h1 shows the gap between lip 302b and web 1, h2 shows the gap between lip 302c and web 1, and hn shows the gap between lip 302n and web 1. As shown in FIG. 5, the gap between each lip and web 1 is designed to hold the relationship of h1<h2< . . . <hn, while setting gap h1 as the basis. Incidentally, in FIG. 5, lip 302a is one which is positioned on the uppermost stream side, while lip 302n is positioned at the lowermost stream side.

W1 shows coating thickness immediately after coating, which is formed by coating solution 305a, W2 shows coating thickness immediately after coating, which is formed by coating solution 305b, and Wm shows coating thickness immediately after coating, which is formed by coating solution 305m. Other symbols are the same as those in FIGS. 2 and 4. The coating thickness immediately after costing, as described in the present invention, means the coating thickness prior to drying and is obtained by the formula described below:

coating thickness immediately after coating=supply amount of a coating solution/(coating width×coating speed)

Each of FIG. 6(a) and FIG. 6(b) is a schematic view showing a coating state employing a three-layer coater in which the distance between each lip and web 1 varies. FIG. 6(a) shows a coater which is assembled employing a method in which production is carried out so that each lip is positioned at the same height, and subsequently, during assembly of each part, a difference in level is provided between each of the lips. In FIG. 6(a) and FIG. 6(b), W3 shows coating thickness immediately after coating which is formed by coating solution 305c, h3 shows a gap between lip 302d and web 1. Other symbols are the same as those in FIGS. 2 and 5. Coater 3 shown in FIG. 6(a) and FIG. 6(b) is one which is assembled so as to hold h1<h2<h3.

As a means to adjust the gap between each lip and web 1 to fall within said range, when the coating thickness of each coating layer is previously determined, coating is carried out employing a coater in which the height of each lip is adjusted to match said coating thickness. The means for adjusting the height of the lip includes methods shown in FIG. 6(a) and FIG. 6(b). However, said means are not limited to these. When a prepared coater, is employed, in which the height of each lip is determined, the coating thickness needs to be adjusted. However, when the coating thickness is varied, the layer thickness after drying deviates from the desired layer thickness, and desired product performance will very likely not be satisfied. In such cases, when the concentration of solids of a coating solution is adjusted, it is possible to only adjust the coating thickness prior to drying without varying the layer thickness after drying.

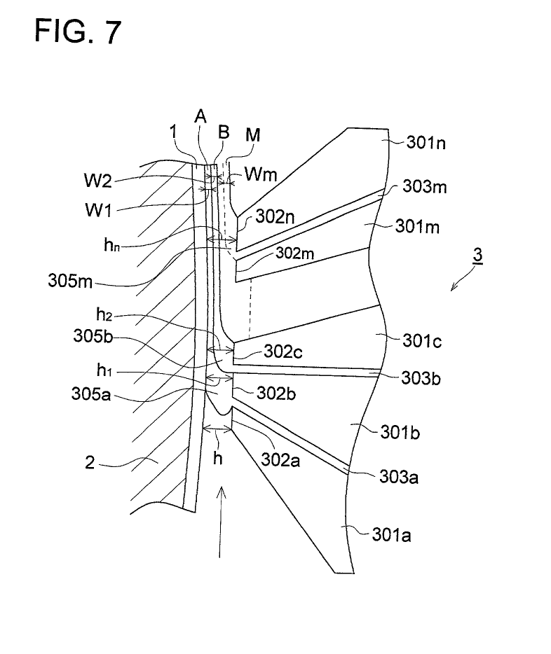

FIG. 7 is a schematic view showing a coating state of the end of a coater during simultaneous multilayer coating, employing a coater in which the distance between each lip and web 1 is the same. Symbols in FIG. 7 are the same as those in FIG. 5. The difference from FIG. 5 is that the gap between each lip and web 1 is designed to satisfy h1=h2 . . . =hn.

When the distance between each lip and web 1 is set to be equal to the coater shown in FIG. 7, the amount of a coating solution, which flows from said lip, decreases as said lip is located on the more up-stream side of said web. As a result, the amount of the coating solution becomes too small for the gap to degrade the stability of the solution flow, whereby it is occasionally impossible to carry out coating due to formation of non-coating spots caused by said inclusion of accompanied air.

In order to overcome said drawbacks, the inventors of the present invention diligently investigated the relationship between gap h between each lip and the web, and the coating thickness. As a result, it was verified that when the relationship described below is satisfied, it is impossible to achieve stable and desired coating:

W≦hn≦3×W

wherein hn represents the gap between support 1 and lip 302n, and W is the total coating thickness (W=W1+W2 . . . +Wm) of each layer (layer A, layer B, . . . layer M) which is formed on further up-stream than lip 302n.

In the multilayer extrusion coating apparatus of the present invention, shown in FIG. 5, the amount of coating compositions increases on the lip of the further lower stream side due to the addition of the coating solutions on the up-stream side. Therefore, it is assumed that at a lip on the further lower stream side in the web moving direction, wider gap h between said lip and the web is effective. Namely, it was discovered that by optimizing the desistance between each lip and the web except for the lip on the uppermost stream side while matching the coating composition amount which flows at each section, desired coating was carried out.

In relatively low viscosity coating solutions, it is occasionally possible to carry out desired coating, even though gap h is not in said range. However, when the viscosity of an adjacent layer solution is 0.01 Pa·s or higher, effects are markedly exhibited.

The back roll employed in the present invention is preferably comprised of a large diameter metallic cylinder at a diameter of at least 200 mm, since its cylindricality affects the accuracy of the gap in the coating width direction between the lip and the web.

Webs employed in the present invention are not particularly limited, and it is possible to employ paper, plastic films, metallic sheets and the like. Listed as paper are for example, resin coated paper, synthetic paper, and the like. Further, listed as plastic films are polyolefin films (for example, polyethylene film, polypropylene film, and the like), polyester films (for example, polyethylene terephthalate film, polyethylene 2,6-naphthalate film, and the like) polyamide films (for example, polyether ketone film, and the like), cellulose acetates (for example, cellulose triacetate, and the like), and the like. Still further, representative metallic sheets are aluminum plates. It is possible to employ these webs which may be subjected to surface treatment, subbing treatment and the like. It is possible to carry out coating onto webs onto which other compositions have been applied. The thickness of the employed webs is not particularly limited.

Coating solutions, which may be employed in the present invention, are not particularly limited. It is possible to employ coating solutions (including subbing layer compositions, overcoating compositions, backing layer compositions, and the like) which are employed, for example, in light-sensitive photographic materials, heat development recording materials, ablation recording materials, magnetic recording materials, steel plate surface processing, and the like.

### EXAMPLES

Example 1

Image recording medias comprising organic silver were prepared employing the methods described below.

(Preparation of Web)

(Preparation of Subbed Web)

Both surfaces of a commercially available 100 μm thick and 1,000 mm wide biaxially stretched polyethylene terephthalate film (hereinafter referred simply to as PET) were subjected to a corona discharge treatment at 8 W/m². Subbing Coating Composition a-1, described below, was applied onto one surface to obtain a dried layer thickness of 0.8 μm, and subsequently dried. The resulting layer was designated as Subbing Layer A-1. Antistatic Treatment Composition b-1, described below, was applied onto the other side surface to obtain a dried layer thickness of 0.8 μm, also and subsequently dried. The resulting layer was designated as Antistatic Treatment Subbing Layer B-1.

<Subbing Coating Composition a-1>

| | | |
|---|---|---|
| Copolymer latex composition (30 percent solids) | 270 | g |
| comprised of butyl acrylate (30 percent by | | |
| weight), t-butyl acrylate (20 percent by | | |
| weight), styrene (25 percent by weight), and | | |
| 2-hydroxyethyl acrylate (25 percent by weight) | | |
| (C-1) | 0.6 | g |
| Hexamethylene-1,6-bis(ethyleneurea) | 0.8 | g |
| Water to make | 1 | liter |

<Subbing Coating Composition b-1>

| | | |
|---|---|---|
| Copolymer latex composition (30 percent solids) | 270 | g |
| comprised of butyl acrylate (40 percent by | | |
| weight), styrene (20 percent by weight), | | |
| glycidyl acrylate (40 percent by weight | | |
| (C-1) | 0.6 | g |
| hexamethylene-1,6-bis(ethyleneurea) | 0.8 | g |
| Water to make | 1 | liter |

Subsequently, the surface of Subbing Layer A-1 and Subbing Layer B-1 was subjected to a corona discharge at 8 W/m². Subbing Upper Layer Coating Composition a-2, described below, was applied onto Subbing Layer A-1 to obtain a dried layer thickness of 0.1 μm, whereby the resulting layer was designated as Subbing Layer A-2. On the other hand, Subbing Upper Layer Coating Composition b-2, described below, was applied onto Subbing Layer B-1 to obtain a dried layer thickness of 0.8 μm, whereby the resulting layer exhibiting antistatic function was designated as Subbing Upper Layer B-2. Thus a subbed support was prepared.

<Subbing Upper Layer Coating Composition a-2>

| Gelatin | weight to result in 0.4 | g/m² |
|---|---|---|
| (C-1) | 0.2 | g |
| (C-2) | 0.2 | g |
| (C-3) | 0.1 | g |
| Silica particles (at an average particle | 0.1 | g |
| diameter of 3 μm) | | |
| Water to make | 1 | liter |

<Subbing Upper Layer Coating Composition b-2>

| | | |
|---|---|---|
| (C-4) | 60 | g |
| Latex composition comprised of (C-5) as the component | 80 | g |
| (20 percent solids) | | |
| Ammonium sulfate | 0.5 | g |
| Polyethylene glycol | 12 | g |
| (at at weight average molecular weight of 600) | | |
| Water to make | 1 | liter |

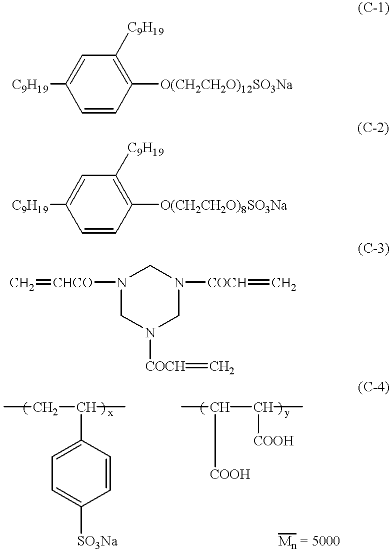

(\overline{M}ₙ=represents a number average molecular weight)

(x:y=75:25 (weight ratio)

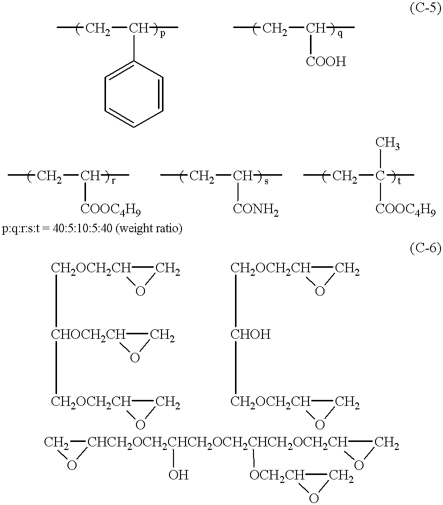

Mixture of the following three compounds

(Heat Treatment of Subbed Support)

In the subbing layer drying process of said subbed layer, said support was heated to 140° C. and gradually cooled.

(Preparation of Back Layer Coated Support)

The back surface coating composition having the composition described below was applied onto Subbing Layer B-2 of the web prepared as above, employing a coater known in the art, and subsequently dried at 60° C. for 15 minutes. The resulting support was employed for coating a light-sensitive layer as well as a protective layer.

(Back Surface Coating Composition)

| | |
|---|---|
| Cellulose acetate (10 percent methyl ethyl ketone solution) | 15 ml/m² |
| Dye-B | 7 mg/m² |
| Dye-C | 7 mg/m² |
| Matting agent: monodispersed silica | 30 mg/m² |
| (at a degree of monodispersion of 15 percent | |
| and an average particle size of 10 μm) | |
| C₉H₁₉—C₆H₄—SO₃Na | 10 mg/m² |

Dye-B

[chemical structure]

Dye-C

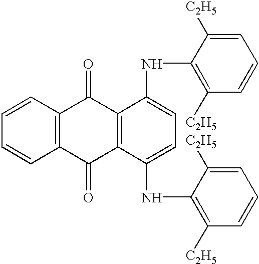

(Coating of Light-Sensitive Layer and Protective Layer)

A light-sensitive layer coating solution and a protective layer coating solution, which were applied onto Subbing Layer A-2 of said back layer-coated web, were prepared.

<Light-Sensitive Layer Coating Solution>

<<Preparation of Silver Halide Emulsion A>>

Dissolved in 900 ml of water were 7.5 g of inert gelatin, and 10 mg of potassium bromide, after which the resulting solution was heated to 35° C., with the pH adjusted to 3.0. Thereafter, 370 ml of an aqueous solution containing 74 g of silver nitrate, and potassium bromide and potassium iodide at a mole ratio of 98/2 in an amount equal mole to silver nitrate, and 370 ml of an aqueous solution, containing Ir(NO)C1₅ in an amount of 1×10⁻⁶ mole per mole of silver and rhodium chloride in an amount of 1×10⁻⁶ mole per silver were added employing a controlled double-jet method while maintaining pAg at 7.7. Thereafter, 4-hydroxy-6-methyl-1,3,3a,7-tatraazaindene was added, and the pH was adjusted to 5 by adding NaOH, whereby cubic silver iodobromide grains at an average grain size of 0.06 μm, a degree of monodispersion of 10 percent, a variation coefficient of projection diameter area of 8 percent, and a ratio of [100] plane of 97 percent were obtained. The resulting emulsion was coagulated employing gelatin coagulants and was subjected to desalting process. Thereafter, 0.1 g of phenoxyethanol was added and the pH and pAg were adjusted to 5.9 and 7.5, respectively, whereby a silver halide emulsion was obtained. Further, the obtained silver halide emulsion underwent chemical sensitization employing chloroauric acid and inorganic sulfur, whereby Silver Halide Emulsion A was prepared.

Said degree of monodispersion and variation coefficient of projection diameter area were calculated employing the formulas described below:

degree of monodispersion=(standard deviation of grain diameter)/(average of grain diameter)×100

variation coefficient of projection diameter area=(standard deviation of projection diameter area)/(average of projection diameter area)×100.

<<Preparation of Sodium Behenate Solution>>

Dissolved at 90° C. in 945 ml of pure water were 32.4 g of behenic acid, 9.9 g of arachidic acid, and 5.6 g of stearic acid. Subsequently, 98 ml of an aqueous 1.5 mole/liter sodium hydroxide solution were added while stirring at high speed. Thereafter, 0.93 ml of concentrated nitric acid was added, and the resulting mixture was then cooled to 55° C. and stirred for 30 minutes, whereby a sodium behenate solution was prepared.

(Preparation of Pre-Form Emulsion)

Added to said sodium behenate solution were 15.1 g of said Silver Halide Emulsion A, with the pH of the resulting mixture adjusted to 8.1 by adding a sodium hydroxide solution. Thereafter, 147 ml of a 1 mole/liter silver nitrate solution were added over 7 minutes and the resulting mixture was stirred for an additional 20 minutes, after which water-soluble salts were removed employing ultrafiltration. Prepared silver behenate was comprised of grains at an average grain size of 0.8 μm, and a degree of monodispersion of 8 percent. After forming the flock of said dispersion, water was removed and further 6 water washings as well as water removal were carried out followed by drying. Subsequently, 107 g of a methyl ethyl ketone solution (17 percent by weight) of polyvinyl butyral (at an average molecular weight of 3,000) were gradually added and mixed. Thereafter, the resulting mixture was subjected to dispersion, employing a media homogenizer, whereby a pre-form emulsion was prepared.

<Preparation of Light-Sensitive Layer Coating Composition>

| | | |
|---|---|---|
| Pre-Form emulsion | 240 | g |
| Sensitizing dye-1 (0.1 percent methanol solution) | 1.7 | ml |
| Pyridinium bromide perbromide (6 percent methanol solution) | 3 | ml |
| Calcium bromide (0.1 percent methanol solution) | 1.7 | ml |
| Antifoggant-2 (10 percent methanol solution) | 1.2 | ml |
| 2-(4-Chlorobenzoylbenzoic acid | 9.2 | ml |
| (12 percent methanol solution) | | |
| 2-mercaptobenzimidazole (1 percent methanol solution) | 11 | ml |
| Tribromomethylsulfoquinoline (5 percent methanol solution) | 17 | ml |
| Developing agent-1 (20 percent methanol solution) | 29.5 | ml |

Sensitizing Dye-1

[chemical structure]

Antifoggant-2

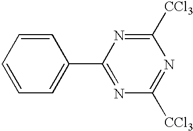

Developing Agent-1

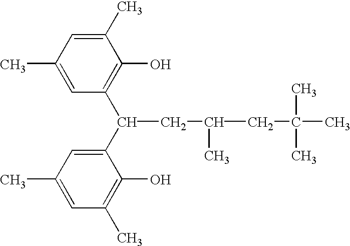

<Surface Protective Layer Coating solution>
<<Preparation of Surface Protective Layer Coating solution>>

| | | |
|---|---|---|
| Acetone | 35 | ml/m² |
| Methyl ethyl ketone | 17 | ml/m² |
| Cellulose acetate | 2.3 | mg/m² |
| Methanol | 7 | ml/m² |
| Phthalazine | 250 | mg/m² |
| 4-Methylphthalic acid | 180 | mg/m² |
| Tetrachlorophthalic acid | 150 | mg/m² |
| Tetrachlorophthalic anhydride | 170 | mg/m² |
| Matting agent | | |
| (monodispersed silica at a degree of | 70 | mg/m² |
| dispersion of 10 percent and an average | | |
| particle size of 4 μm) | | |
| C₉H₁₉-C₆H₄-SO₃Na | 10 | mg/m² |

Employing said light-sensitive layer coating solution as well as said surface protective layer coating solution, three layers (a lowermost layer, an adjacent layer and a protective layer or an uppermost layer) were simultaneously multilayer-coated. At that time, the viscosity of the lowermost layer solution and the adjacent layer solution was varied and samples shown in Table 1 were prepared. As the lowermost layer solution, said light-sensitive layer coating solution was employed, and the viscosity was varied by diluting said solution with methyl ethyl ketone (MEK). As the adjacent layer solution, the aforementioned light-sensitive layer coating solution was employed, and the viscosity was varied by diluting said solution with MEK. Incidentally, coating was carried out to achieve a coating speed of 100 m/minute, a coating width of 950 mm, an uppermost layer coating thickness of 10 μm, and a lowermost layer coating thickness of 10 μm.

TABLE 1

| Sample No. | a | b | b/a | Remarks |
|---|---|---|---|---|
| 1-1 | 500 | 500 | 1.0 | Comparative |
| 1-2 | 250 | 500 | 2.0 | Comparative |
| 1-3 | 200 | 500 | 2.5 | Present |
| | | | | Invention |
| 1-4 | 100 | 500 | 5.0 | Present |
| | | | | Invention |
| 1-5 | 50 | 500 | 10.0 | Present |
| | | | | Invention |
| 1-6 | 200 | 250 | 1.3 | Comparative |
| 1-7 | 100 | 250 | 2.5 | Present |
| | | | | Invention |
| 1-8 | 50 | 250 | 5.0 | Present |
| | | | | Invention |
| 1-9 | 22.5 | 250 | 11.1 | Present |
| | | | | Invention |
| 1-10 | 20 | 250 | 12.5 | Present |
| | | | | Invention |

In Table 1, “a” represents the viscosity (in mPa·s) of the lowermost layer solution, and “b” represents the viscosity (in mPa·s) of the adjacent layer solution.

Table 2 shows the lower limit of the coating thickness of the adjacent layer when coating was carried out under the conditions shown in Table 1. The lower limit of the coating thickness of the adjacent layer, as described herein, refers to the value obtained as follows: the supply amount of the adjacent layer coating composition was gradually decreased, the coating state is visually noted, and the supply amount which makes it impossible to carry out coating is determined, after which said value was calculated employing the formula, described below, based on the coating width and coating speed.

Lower limit coating thickness (in μm) of the adjacent layer=supply amount of the coating composition per unit time/(coating speed per unit time×coating width)

TABLE 2

| | (Lower Limit | | |
|---|---|---|---|
| | Coating Thickness | | |
| | of Adjacent Layer | | |
| Sample No. | in μm) | Remarks | X |
| 1-1 | 90 | Comparative | 0.1 |
| 1-2 | 75 | Comparative | 0.3 |
| 1-3 | 30 | Present | 0.8 |
| | | invention | |
| 1-4 | 24 | Present | 2.1 |
| | | invention | |
| 1-5 | 20 | Present | 5.0 |
| | | invention | |
| 1-6 | 55 | Comparative | 0.2 |
| 1-7 | 22 | Present | 1.1 |
| | | invention | |
| 1-8 | 15 | Present | 3.3 |
| | | invention | |
| 1-9 | 15 | Present | 7.4 |
| | | invention | |
| 1-10 | 15 | Present | 8.3 |
| | | invention | |

In Table 2, “X” represents (b/a)/(c/d), when coating was carried out at the lower limit coating thickness of the adjacent layer. In the formula, “c” is the coating thickness (in μm) of the adjacent layer, and “d” is the coating thickness (in μm) of the lowermost layer. Incidentally “a” and “b” are the same as those in Table 1.

As shown in Table 2, it was confirmed that when (b/a)≦2.5 of the present invention was satisfied, it was possible to carry out stable thin layer coating. Samples 1-3, 1-4, 1-5, 1-7, 1-8, and 1-9, which satisfied (b/a)/(c/d)<7.5 which is the more preferable embodiment of the present invention, resulted in neither non-uniform coating nor non-uniform layer thickness, whereby it was possible to obtain excellent performance during thin layer coating.

Example 2

When experiments of Example 1 were carried out, each of the lowermost layer coating compositions was replaced with each of the coating compositions shown in Table 3. Further, the coating thickness of the adjacent layer was set at 30 μm and the coating thickness of the lowermost layer was set at 3 μm. Then coating was carried out under conditions, other than those, which were the same as Example 1. Table 3 shows the results which are obtained by visually observing the state of the resulting coating surface.

TABLE 3

| | Lowermost | | | | | |
|---|---|---|---|---|---|---|
| | Layer | | | | State of | |
| Sample | Coating | | | | Coating | |
| No. | Composition | a | b | b/a | Surface | Remarks |
| 2-1 | toluene | 0.6 | 500 | 833 | mottle was | Present |
| | | | | | partially | Invention |
| | | | | | noted | |
| 2-2 | MEK | 0.4 | 500 | 1250 | excellent | Present |
| | | | | | | Invention |
| 2-3 | acetone | 0.3 | 500 | 1667 | mottle was | Present |
| | | | | | partially | Invention |
| | | | | | noted | |
| 2-4 | water | 1.0 | 500 | 500 | streaking | Present |
| | | | | | was noted | Invention |
| | | | | | in the | |
| | | | | | lowermost | |
| | | | | | layer | |
| | | | | | adjacent | |
| | | | | | layer | |

In Table 3, “a” represents the viscosity (in mPa·s) of the lowermost layer coating composition, and “b” represents the viscosity (in mPa·s) of the adjacent layer coating composition.

As shown in Table 3, when as the lowermost coating composition, the solvent comprised in the adjacent layer was employed, it was possible to obtain the coating layer in which the state of the coating surface was excellent (in the case in which as the lowermost coating composition, the solvent which was different from the adjacent layer, mottle was partially noted, even though said mottle was at a commercially viable level.).

Example 3

Samples were prepared by carrying out coating under the same conditions as Example 1, except that the thickness of the adjacent layer was varied to 30 μm. Then, the upper limit coating speed (in m/minute), which resulted in no mottle, was determined. Table 4 shows the results. Incidentally, the upper limit coating speed, as described herein, refers to the highest coating speed which makes it possible to carry out coating, when the coating speed is increased.

TABLE 4

| Sample | | | | | |
|---|---|---|---|---|---|
| No. | a | b | b/a | e | Remarks |
| 3-1 | 500 | 500 | 1.0 | 30 | Comparative |
| 3-2 | 250 | 500 | 2.0 | 50 | Comparative |
| 3-3 | 200 | 500 | 2.5 | 100 | Present |
| | | | | | Invention |
| 3-4 | 100 | 500 | 5.0 | 135 | Present |
| | | | | | Invention |
| 3-5 | 50 | 500 | 10.0 | 160 | Present |
| | | | | | Invention |
| 3-6 | 200 | 250 | 1.25 | 45 | Comparative |
| 3-7 | 100 | 250 | 2.5 | 110 | Present |
| | | | | | Invention |
| 3-8 | 50 | 250 | 5.0 | 190 | Present |
| | | | | | Invention |
| 3-9 | 22.5 | 250 | 11.1 | 220 | Present |
| | | | | | Invention |
| 3-10 | 20 | 250 | 12.5 | 250 | Present |
| | | | | | Invention |

In Table 4, “a” represents the viscosity (in mPa·s) of the lowermost layer coating composition, and “b” represents the viscosity (in mPa·s) of the adjacent layer coating composition. “e” represents the upper limit coating speed (in m/second).

As shown in Table 4, it was confirmed that when b/a≧2.5 of the present invention was satisfied, it was possible to carry out high speed coating.

Example 5

Samples were prepared as follows. The back layer-coated web shown in Example 1 was employed. Employing the light-sensitive layer coating solution and the protective layer coating solution shown in Example 1, three layers (an uppermost layer, an adjacent layer, and a protective layer or an uppermost layer) were simultaneously multilayer-coated onto Subbing Layer A-2 of said back layer-coated web, employing the extrusion coater shown in FIG. 6(a). During coating, distance h1 between lip 302b between the lowermost layer and the adjacent layer, and web 1 was adjusted as shown in Table 6, and the coating adaptability of said adjacent layer was tested. Table 6 shows the results. Incidentally, distance h2 between lip 302c and support 1 was kept constant at 100 μm, while distance h3 was kept constant at 120 μm. As the lowermost layer coating composition, said light-sensitive layer coating composition was employed, and the viscosity was adjusted to 100 mPa·s by diluting said composition with methyl ethyl ketone. As the adjacent layer coating composition, said light-sensitive layer coating composition was employed, and the viscosity was adjusted to 500 mPa·s by diluting said composition with methyl ethyl ketone. Accordingly, in all samples, (b/a)=5 was held and (b/a)≧2.5 was satisfied. Incidentally, coating was carried out to achieve a coating speed of 100 m/minute, a coating width of 950 mm, a lowermost layer coating thickness of 10 μm, an adjacent layer coating thickness of 30 μm, and a protective layer (an uppermost layer) coating thickness of 10 μm. Coating adaptability was visually observed and the resulting coating state was relatively evaluated based on four grades A through D.

A: excellent

B: good

C: non-uniform area was noted at very few portions

D: non-uniform was noted, though it resulted in no commercial viability

TABLE 6

| | | Coating | |
|---|---|---|---|
| | | Adaptability | |
| | Distance h1 | of Adjacent | |
| Sample No. | (in μm) | Layer | Remarks |
| 5-1 | 100 | D | Present |
| | | | Invention |
| 5-2 | 50 | C | Present |
| | | | Invention |
| 5-3 | 30 | A | Present |
| | | | Invention |
| 5-4 | 20 | A | Present |
| | | | Invention |
| 5-5 | 15 | A | Present |
| | | | Invention |
| 5-6 | 10 | A | Present |
| | | | Invention |
| 5-7 | 8 | B | Present |
| | | | Invention |

All samples shown in Table 6 satisfied the relationship of (b/a)≧2.5, but were included in the preferable embodiments of the present invention. When the distance between the lip between the lowermost layer and the adjacent layer, and the support was 1 through 3 times greater than the thickness of the lowermost layer, it was confirmed that coating adaptability was more preferable.

Example 9

Magnetic recording materials for a floppy disk capable of recording 100 MB or more was prepared employing the methods described below.

<Preparation of Coating Solutions>

<Magnetic layer coating solution: Upper layer>

| | | |
|---|---|---|
| Ferromagnetic metal powder (Hc: 2350 Oe, σs: 155 emu/g, | 100 | part |
| average major axis: 0.1 μm, specific surface area: 50 m²/g) | | |
| Chloroethylene copolymer (produced by Nihon Zeon: | 10 | parts |
| MR110, polymerization degree: 300) | | |
| polyurethane resin (produced by Toyobo: UR8300) | 5 | parts |
| carbon black (produced by Colombia Carbon: | 1 | part |
| ConducteX975) | | |
| alumina (produced by Sumitomo Kagaku: HIT50) | 10 | parts |
| diamond fine powder: average grain diameter 0.3 μm | 1 | part |
| phenylphosphonic acid | 3 | parts |
| butylstearate | 10 | parts |
| butoxyethylstearate | 5 | parts |
| isohexadecylstearate | 3 | parts |
| stearic acid | 2 | parts |
| methylethylketone | 180 | parts |
| cyclohexianone | 180 | parts |

<non-magnetic layer coating solution>

| | |
|---|---|
| non-magnetic powder: needle-type hematite | 100 parts |
| (produced by Toda Kogyo: DPN550BX, average | |
| major axis: 0.14 μm, specific surface area: | |
| 50 m²/g, average minor axis: 0.024 μm) | |
| carbon black (produced by Colombia Carbon: | 12 parts |
| ConducteX average primary particle: not more | |
| than 20 nm) | |
| Chloroethylene copolymer (produced by Nihon | 15 parts |
| Zeon: MR104, polymerization degree: 250) | |
| polyurethane resin (produced by Toyobo: | 6 parts |
| UR8300) | |
| phenylphosphonic acid | 4 parts |
| butylstearate | 10 parts |
| butoxyethylstearate | 5 parts |
| isohexadecylstearate | 2 parts |
| stearic acid | 3 parts |
| methylethylketone | adjusted appropriately |
| | in the range from |
| | 50 to 150 parts |
| cyclohexianone | 100 parts |

The components of each of the above-obtained magnetic layer solution and non-magnetic layer solution were kneaded by a kneading machine, respectively. After that, the above-described diamond fine powder was incorporated into the magnetic layer solution and each of the magnetic layer solution and the non-magnetic layer solution was dispersed by sand mill. To each of the non-magnetic layer solution and the magnetic layer solution, 13 parts and 4 parts of polyisocyanete (produced by Nippon Polyurethane: Coronate L) was incorporated, respectively. Further, 40 parts of cyclohexanone was incorporated into each of the solution and the each of the solution was filtrated by a filter having average bore diameter of 1 μm.

Samples shown in Table 10 were prepared by applying said magnetic layer coating solution for the upper layer and said non-magnetic layer coating solution for the lower layer, employing the coater shown in FIG. 4, while varying the viscosity of the lowermost coating composition. Incidentally, as the lowermost layer non-magnetic coating composition, said non-magnetic layer coating composition for the upper layer was employed, and the viscosity was varied by diluting said composition with methyl ethyl ketone. As the adjacent layer coating composition, said magnetic layer coating composition for the upper layer was employed, and the viscosity was kept constant at 1.5 Pa·s. The lowermost layer non-magnetic coating composition and the magnetic layer coating composition, which was positioned on said non-magnetic layer, were simultaneously applied onto a 950 mm wide and 62 μm thick polyethylene terephthalate film at a central surface roughness of 3 nm so as to obtain a thickness of 1.5 μm and 0.2 μm, respectively, after drying. When coating carried out under the above conditions, adjacent layer coating lower limit layer thickness was measured. Table 11 shows the results. The adjacent layer coating lower limit layer thickness, as described herein, refers to the value obtained as follows: viscosity g of he adjacent layer coating composition is kept constant and viscosity f of the lowermost layer coating composition is varied; at each viscosity, the supply amount if said coating composition is gradually decreased and the supply amount of said costing composition, which makes impossible to carry out coating is determined, and said value was calculated employing the formula, described below, based on the coating width and coating speed.

Adjacent layer coating lower limit layer thickness (in μm)=supply amount of the coating composition per unit time/(coating speed per unit time×coating width)

TABLE 10

| Sample No. | f | g | g/f | Remarks |
|---|---|---|---|---|
| 9-1 | 1.5 | 1.5 | 1.0 | Comparative |
| 9-2 | 1.0 | 1.5 | 1.5 | Comparative |
| | | | | Present |
| 9-3 | 0.5 | 1.5 | 3.0 | Invention |
| 9-4 | 0.3 | 1.5 | 5.0 | Present |
| | | | | Invention |
| 9-5 | 0.1 | 1.5 | 15.0 | Present |
| | | | | Invention |
| 9-6 | 0.05 | 1.5 | 30.0 | Present |
| | | | | Invention |

In Table 10, “f” represents the viscosity (in Pa·s) of the lowermost layer coating composition, and “g” represents the viscosity (in Pa·s) of the adjacent layer coating composition.

TABLE 11

| | Adjacent Layer Coating Lower | |
|---|---|---|
| Sample No. | Limit Layer Thickness (in μm) | X |
| 9-1 | 75 | 0.1 |
| 9-2 | 55 | 0.3 |
| 9-3 | 27 | 1.1 |
| 9-4 | 23 | 2.2 |
| 9-5 | 21 | 7.1 |
| 9-6 | 19 | 15.8 |

In Table 11, “X” represents (g/f)/(i/j), wherein “i” is an adjacent layer coating thickness (in μm) and “j” is a lowermost layer coating thickness (in μm). Incidentally, “g” and “f” is the same as Table 1.

As shown in Table 2, when the condition of (g/f)≧2.5 of the present invention is satisfied, it was confirmed that it was possible to carry out stable thin layer coating. Samples 9-3, 9-4 and 9-5, which satisfy (b/a)/(c/d)<7.5, resulted in neither non-uniform coating nor non-uniform layer thickness. Thus, it was possible to obtain further excellent performance during thin layer coating.

### EFFECTS OF THE INVENTION

According to the present invention, it is possible to carry out high-speed thin layer simultaneous multilayer coating of high viscosity coating compositions at extrusion coating employing a coater in which a support is held by a back roll.

What is claimed is:

1. An extrusion coating method of extruding a coating solution from a coater onto a web-shaped substrate, comprising steps of:
conveying the substrate in a conveying direction;
supporting by coming in contact with a first side surface of the substrate by a back-roll; and
extruding simultaneously at least a lowermost layer solution and an adjacent layer solution onto a second side surface of the supported substrate in such a way that the lower most layer solution is coated on the second surface and the adjacent layer is superimposed on the lowermost layer solution,
wherein a viscosity Va (Pa·s) of the lowermost layer solution and a viscosity Vb (Pa·s) of the adjacent layer solution satisfy the following formula.
Vb/Va≦2.5

2. The extrusion coating method of claim 1, wherein the viscosity Va, the viscosity Vb, a thickness Ta (μm) of the lowermost layer solution and a thickness Tb of the adjacent layer solution satisfy the following formula.
(Vb/Va)/(Tb/Ta)<7.5

3. The extrusion coating method of claim 1, wherein the viscosity Va and the viscosity Vb satisfy the following formula.
2.5≧(Vb/Va)≧30

4. The extrusion coating method of claim 2, wherein the viscosity Va, the viscosity Vb, the thickness Ta and the thickness Tb satisfy the following formula.
0.8≦(Vb/Va)/(Tb/Ta)<7.5

5. The extrusion coating method of claim 1, wherein the adjacent layer solution is a solution diluting the lowermost layer solution.

6. The extrusion coating method of claim 1, wherein the viscosity Vb is not less than 0.01 Pa·s.

7. The extrusion coating method of claim 6, wherein the viscosity Vb is not more than 3.0 Pa·s.
